(19) United States
(12) Patent Application Publication
(10) Pub. No.: US 2003/0103251 A1
(43) Pub. Date: Jun. 5, 2003

(54) Artwork creation process using copier

(76) Inventor: Blossom A. Sanger, Coronado, CA (US)

Correspondence Address: CHARMASSON & BUCHACA, 1545 HOTEL CIRCLE SOUTH, SUITE 150, SAN DIEGO, CA, 92108-3412, US

(21) Appl. No.: 10/010,889

(22) Filed: Dec. 4, 2001

(51) Int. Cl. H04N 1/387; H04N 1/46

(52) U.S. Cl. 358/540; 358/450

(57) ABSTRACT

An original work of graphic art is composed using a photocopying machine having discrete, color specific scanning cycles. An object such as a flower is first positioned on the platen of the photocopying machine. A background image is held above the object, and the object itself or the background image is moved during at least one of the machines' scanning cycles. Alternately, a light source, instead of a background image, is held above the object and either or both the object and the light source are moved during at least one of the scanning cycles.

### FIELD OF THE INVENTION

This invention relates to methods for creating works of graphic art, and more specifically for creating abstract compositions and whimsical background images.

### BACKGROUND OF THE INVENTION

Graphic artists rely on illusions, suggestions and symbolism in order to convey a message, create a mood or subliminally condition the mind of the observer. Realistic reproductions is often avoided in favor of distorted or barely sketched images. Lines between discrete objects may be blurred. Colors are allowed to bleed into one another. Shadows can clair-obscurs are distorted, and whimsical shapes of varying hues may be scattered throughout the workpiece.

All of these special effects must be painstakingly drawn or physically composed by some mechanical process. Artists have resorted to various techniques to achieve the desired effects, from the wild paint sprinkling of a Jackson Pollock to the unfocused coloring of of an Andy Warhol. Computer art has opened new avenues of graphic renditions going far beyond the repetitive, geometric patterns of a Viktor Vasarely in order to create a wide variety of complex arrangements.

Graphic renditions whether manual or computerized still require a great deal of time and effort.

The blending of images as disclosed in U.S. Pat. No. 6,281,904 Reinhardt et al. may involve photographic reproductions followed by computer manipulation. Computer-aided creation of geometrical patterns as disclosed in U.S. Pat. No. 4,885,193 Head requires the preparation of a long list of program instructions. The filter and negative pasted-up process disclosed in U.S. Pat. No. 4,937,177 Hubert is a multi-step process that can extend over a long period of time.

The instant invention results from an attempt to develop a more rapid and more practical method for creating some of the above-described special effects.

### SUMMARY OF THE INVENTION

The principal and secondary objects of this invention are to provide a convenient, rapid and inexpensive method for composing works of graphic art that does not require the detailed drawing of each design element; and to take advantage of the particular operation of some copying machines.

These and other valuable objects are achieve by use of a multi-color photocopying machine that uses multiple color-specific scanning sequences of the object to be reproduced.

Objects placed in front of the photocopier platen are distorted and their colors blended, in part, by moving the objects or their lighting during one or more of the machine's scanning cycles.

### BRIEF DESCRIPTION OF THE DRAWING

FIG. 1 is a diagrammatical view of the various elements used in the practice of the claimed method; and

FIGS. 2-4 are block diagrams of alternate applications of the claimed method.

### DESCRIPTION OF THE PREFERRED EMBODIMENT OF THE INVENTION

Referring now to the drawing, there is illustrated a method for creating a work of graphic art according to the claimed invention. The method makes use of a multicolor photocopying machine such as a CANON R brand of laser photocopier in which the platen is sized and horizontally positioned to hold a document to be copied.

A translucent background image 1 is held spaced apart from the platen 2 of the photocopying machine 3 having a plurality of color-specific scanning cycles. An object 4, such as a flower, is positioned between the background image 1 and the platen 2, preferably laid directly upon it or above a transparent film 5 placed over the platen. After initiating the scanning process, either the background image 1 or the object 4 is moved during at least one of the scanning cycles. The object can be conveniently moved by pulling on an edge of the transparent film 5. The background image 1 may be backlighted during the process by a floodlight 6 or other light source.

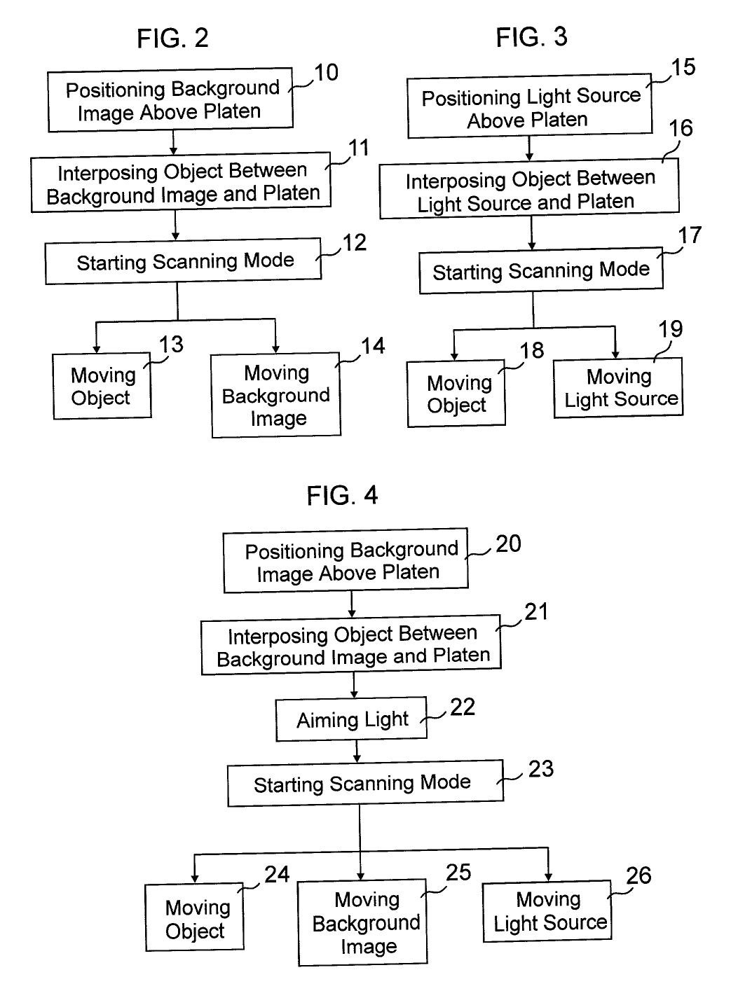

As more specifically illustrated in the block diagrams of FIGS. 2-4, any one or any combination of the object 4, the background image 1 and the light source 6 may be moved during one or more of the photocopying machine's scanning cycles.

In a first example illustrated in FIG. 2, after positioning 10 the background image above the platen and interposing 11 an object between the background image and the platen, the scanning process is started 12, and either one of the object or the background image is moved 13, 14 during at least one of the scanning cycles of the photocopying machine.

In a second example, illustrated in FIG. 3, a light source is positioned 15 above the platen, and an object is interposed 16 between these elements. After starting 17 the scanning mode, either the object or the light source is moved 18, 19.

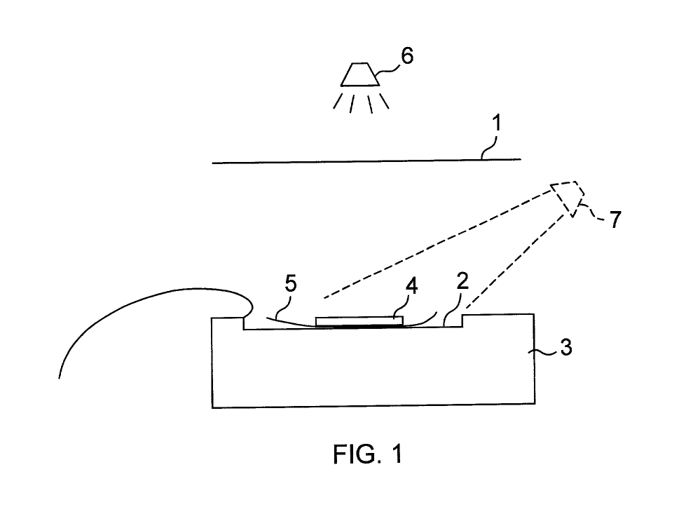

In a third example illustrated in FIG. 4, both a background image and a light source are used. The light source may either be used to backlight the translucent background image or may be focused laterally on the object as shown 7 in dotted line in FIG. 1. Thus, after positioning 20 the background image above the platen and interposing 21 the object between them, a light source is aimed 22 toward the background image, the object or both of them. After starting the scanning process 23, either one of any combination of the object, background image and light source is moved 24, 25, 26 during one of the scanning cycles.

When the background image is moved, it is preferably translated in the plane parallel and spaced apart from the surface of the platen 2.

While the preferred embodiments of the invention have been described, modifications can be made and other embodiments may be devised without departing from the spirit of the invention and the scope of the appended claims.

What is claimed is:

1. A method for composing a work of graphic art which comprises:
using a photocopying machine having a platen sized and positioned to hold a document to be reproduced, and means for scanning said document in at least one scanning cycle;
holding over said platen at least two objects, a first of said objects being held at a different distance from said platen than a second one of said objects;
operating said means for canning, and moving at least one of said objects in relation to the other during at least a part of said scanning cycle.

2. The method of claim 1, wherein said step of holding a second object comprises holding a background image; and
said step of moving at least one of said objects comprises translating said image in a plane substantially parallel to said platen.

3. The method of claim 1, wherein said step of using a photocopying machine comprises using a multi-color copying machine having a plurality of color-specific scanning cycles; and
said step of moving at least one of said objects comprises translating said object during at least one of said scanning cycles.

4. The method of claim 1, wherein said step of holding comprises positioning said first object nearest said platen; and
wherein said second object comprises a light source.

5. The method of claim 4, which further comprises holding a translucent image between said first object and said light source.

6. The method of claim 2, wherein said step of using a photocopying machine comprises using a multi-color copying machine having a plurality of color-specific scanning cycles; and
said step of moving at least one of said objects comprises translating said object during at least one of said scanning cycles.

7. The method of claim 5, wherein said step of using a photocopying machine comprises using a multi-color copying machine having a plurality of color-specific scanning cycles; and
said step of moving at least one of said objects comprises translating said object during at least one of said scanning cycles.

8. The method of claim 2, which further comprises backlighting said background with a light source.

9. The method of claim 8, which further comprises translating said light source during at least one of said scanning cycles.

10. The method of claim 7, which further comprises translating said light source during at least one of said scanning cycles.
